(19) United States
(12) Patent Application Publication
(10) Pub. No.: US 2005/0273331 A1
(43) Pub. Date: Dec. 8, 2005

(54) Automatic animation production system and method

(75) Inventor: Tse-Jen Lu, HsinTien (TW)

Correspondence Address: BRUCE H. TROXELL, SUITE 1404, 5205 LEESBURG PIKE, FALLS CHURCH, VA, 22041, US

(73) Assignee: Reallusion Inc.

(21) Appl. No.: 11/143,661

(22) Filed: Jun. 3, 2005

(30) Foreign Application Priority Data
Jun. 4, 2004 (TW) 93116054

(51) Int. Cl. G10L 15/00; G06K 9/00

(52) U.S. Cl. 704/246; 382/118; 345/473

(57) ABSTRACT

The present invention provides an automatic animation production system and method. The automatic animation production system creates animations by synthesizing various facial features according to audio analysis. By expanding animation parameters in a scenario template database according to audio analysis data, facial features in an image are varied with time, thereby creating animation. The scenario template database comprises a plurality of animation parameters. Combinations of various animation parameters can create various facial expressions in an image, in accompany with variations of audio, enriched effects are available.

### 1. FIELD OF THE INVENTION

The present invention relates to an automatic animation production system and method, and in particular to automatic animation production system and method creating synchronized animations by synthesis various facial features according to audio analysis.

### 2. BACKGROUND OF THE INVENTION

In a conventional animation technology, voice analysis is often used to obtain mouth shape variation data along with time of voicing which simulates speaking of the image. Although such a process can be automated, only mouth shape variation is present without other facial expressions. In the conventional technology, users must use an appropriate animation tool such as Timeline Editor to edit animation with respect to corresponding time axis for enriching the facial expression (Key Frame Animation method). Such animation tools includes an edit interface of sound wave versus time on which a time point is selected, a key frame is added to the time point, the key frame is edited and transition is assigned. After repeating the described step, an animation rich in facial expressions is available. In general, certain basic edit functions such as “delete” and “duplicate” are added to the animation tool for easy use.

The described animation edit, however, has three drawbacks:
1. It is complicated to edit facial expressions with respect to time axis so that it is only suitable for users professional in animation production.
2. Minute and complicated edit animation tools and input equipment are needed to edit animation with respect to time axis so that a longer editing time is needed, and such functions cannot be easily performed in limited input equipment such as a mobile phone.
3. Because the edit is performed with respect to specific voice-time axis, it needs to re-edit when voice data changes.

### SUMMARY OF THE INVENTION

Accordingly, an object of the invention is to provide an automatic animation production system and method, and in particular to provide an automatic animation production system and method creating synchronized animations by synthesis various facial features according to audio analysis.

Another object of the invention is to provide a scenario template selection system and method driven by audio or event. When users input audio and select the desired scenario, an animation with enriched facial expression is created.

Another object of the invention is to provide a scenario template database in which the classified facial adjusting parameters from key frames are stored. When a scenario is selected, the system and method of the invention analyses the input audio to discriminate different sections in which various animations is added according to the selected scenario. Thus, the same scenario template can be used for audio with different lengths.

Another object of the invention is to provide a simple animation production system and method. A user only need to input image, input audio and select template, an enriched animation is created. It is quite suitable for limited input equipment in frequent use, for example a mobile phone sending a message.

A detailed description is given in the following embodiments with reference to the accompanying drawings.

### BRIEF DESCRIPTION OF THE DRAWINGS

FIG. 1A is a block diagram of a system of the invention;

FIG. 1B is a block diagram of an embodiment of a system of the invention;

FIG. 2 is a schematic view of an embodiment of facial features detection of the invention;

FIG. 3 is another schematic view of an embodiment of facial features detection of the invention;

FIG. 4 is a schematic view of an embodiment of audio analysis of the invention;

FIG. 5 is a schematic view of an embodiment of scenario template versus audio of the invention;

FIG. 6 is a schematic view of a scenario template of the invention;

FIG. 7 is a schematic view of an embodiment of a scenario template of the invention;

FIG. 8 is a flow chart of a scenario template processing module of the invention;

FIG. 9 is a schematic view showing animation parts distribution in a scenario template of the invention;

FIG. 10 is a schematic view showing animation state distributed in a scenario template of the invention; and

FIG. 11 is a flow chart showing operation of a system of the invention.

FIG. 12 is another schematic view showing animation state matched in a scenario template of the invention; and

### DESCRIPTION OF THE PREFERRED EMBODIMENT

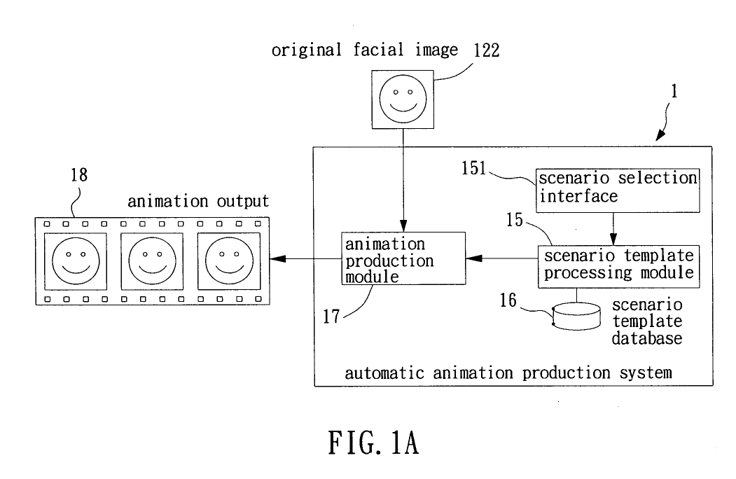

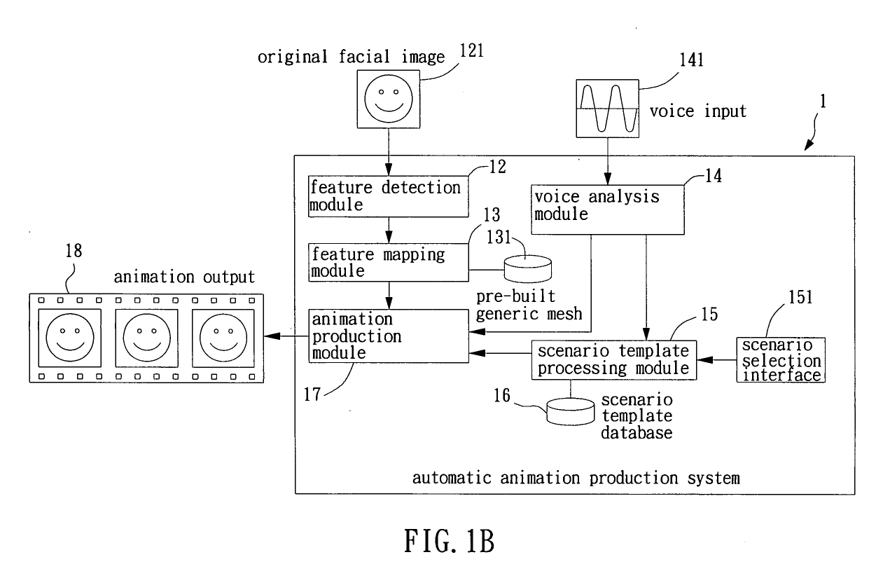

FIG. 1A is a block diagram of a system of the invention. Referring to FIG. 1A, an automatic animation production system 01 comprises a scenario selection interface 0151 for selecting scenario templates, a scenario template database 016 storing scenario template data, a scenario template processing module 015 for processing the selected scenario template to generate feature parameters, and a animation production module 017 for loading feature parameters and generating animation frame to produce animation. In the beginning, animation production module is initialized to be ready for receiving animation parameters and generating animation frame. When the animation production module is ready, users can select a scenario template from the scenario template database 016 via the scenario selection interface 0151. The syncing event and the selected scenario template are processed by the scenario template processing module 015. The scenario template processing module expanding the selected scenario template into a dynamic sequence of animation parameters. Finally, the animation production module 017 loads the dynamic sequence of animation parameters to create animation frame and produce animation.

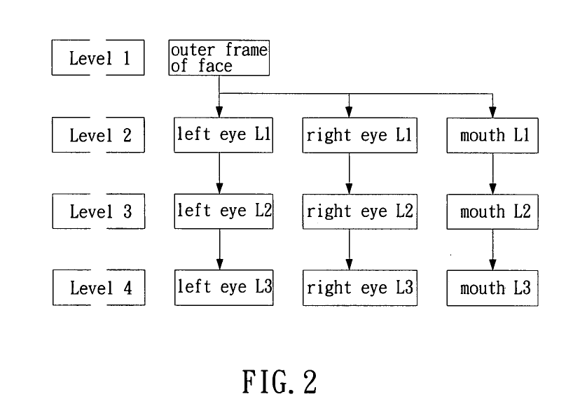

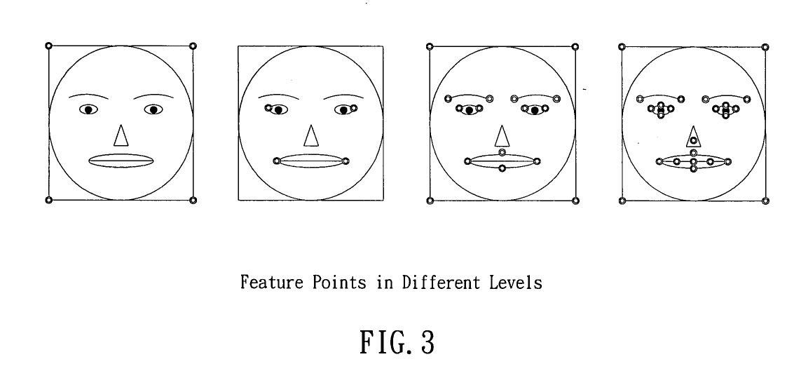

Referring to FIG. 1B, the automatic animation production system 01 further comprises a feature detection module 012, a geometry construction module 013, and an audio analysis module 014. In the beginning, an image reading unit outside the automatic animation production system of the invention reads an original facial image 0121. The read facial image 0121 is input into the feature detection module 012 for feature recognition. After the recognition, the related facial features are positioned. The geometry construction module 013 compares the feature points recognized by the feature detection module 012 with a pre-built generic mesh 0331 and converts the features to a useful geometry data in animation production. As shown in FIG. 2, the system of the invention utilizes a progressive geometry construction method, whereby the feature points are divided into groups according to different face portions and several levels according to resolution. A correlation between each level is built. The generic mesh data are also divided into groups according to the groups of feature points. When processing, the feature points are adjusted to map the corresponding generic mesh. A correct mesh data is obtained by repeating the adjustment. If the adjustment is performed in a system of full capability such as a desktop, the feature points can be completely obtained. If the adjustment is performed in a system of limited capability such as a PDA or a mobile phone, only the features in low levels are obtained (an approximate result is obtained). In real environment, the former are built-in data offered by the manufacturer, and the later are real time data operated by users. The original facial image 0121 is processed by the feature detection module 012 and the geometry construction module 013. The result is shown in FIG. 3.

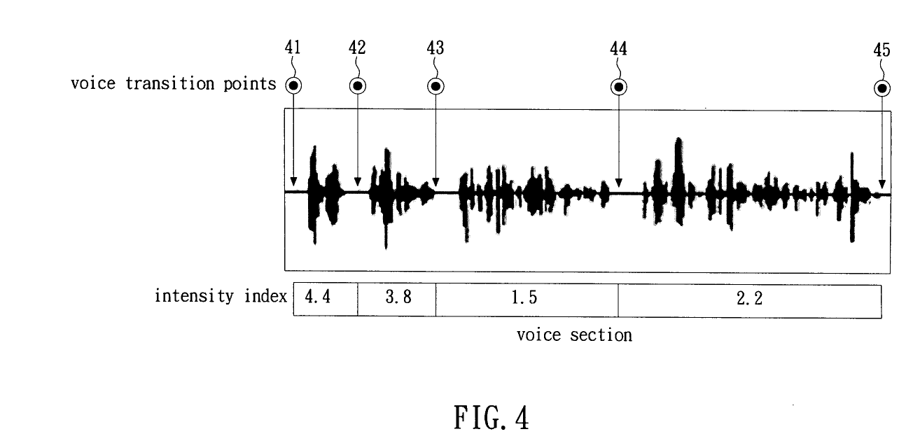

The audio analysis module 014 shown in FIG. 1 comprises a voice analysis unit well known in prior art and an audio analysis unit for analyzing audio characteristics. Audio data recorded by users are recognized and analyzed by the voice analysis module 014. The voice analysis unit converts the audio data into phonetic data which include the period of the phonetic data. The audio analysis unit divides the audio data into various sections according to the characteristic of the audio and outputs the characteristic data (energy) and time information (initial time and period) of the section to the scenario template processing module. The result of recognition and analysis is shown in FIG. 4. As shown in FIG. 4, the recognized audio data has five transition points 041, 042, 043, 044 and 045 which represent the audio variations in certain conditions such as angry, happy.

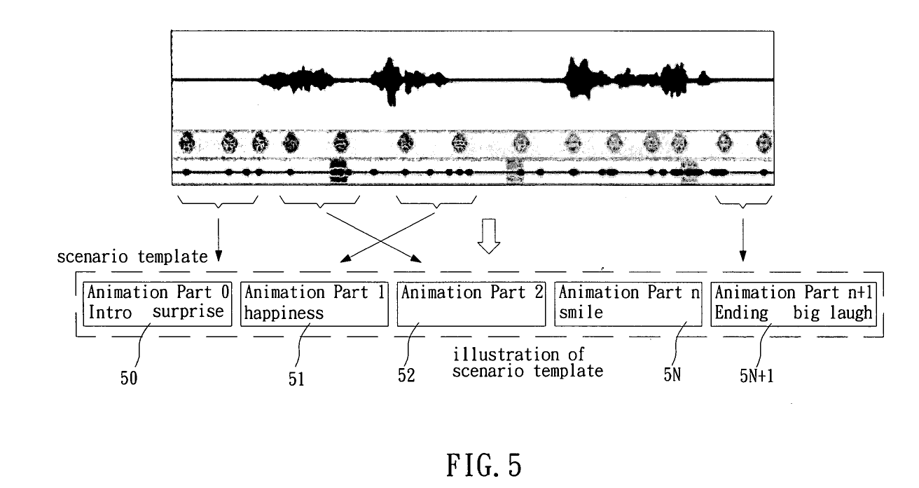

The audio data is divided into several sections including characteristic data by the audio analysis module as shown in FIG. 5. The scenario template processing module is expanding the scenario template data according to the number of audio sections.

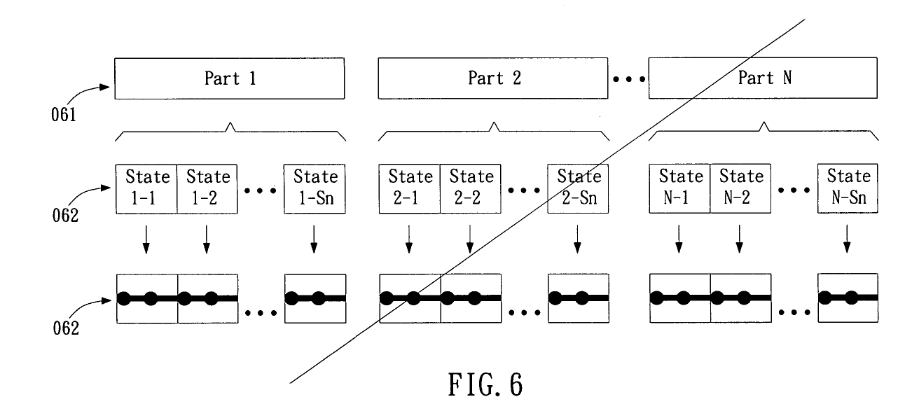

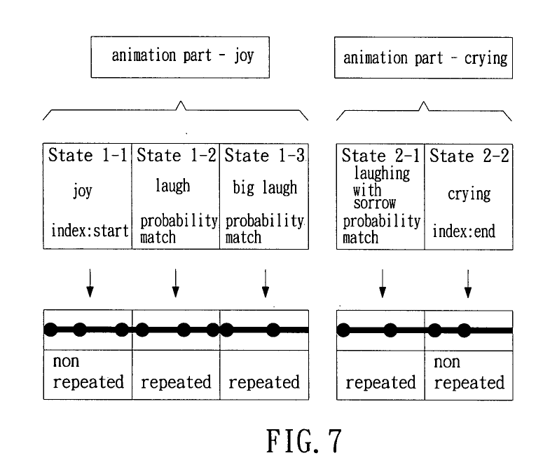

As shown in FIG. 6, the scenario template data has three main portions, the animation part 061, the animation state 062 and the animation parameters 063. The animation part represents the sequence of animation. An animation part can match to one or more audio sections. The animation state constitutes the animation part. One animation state maps to only one audio section but can be reused. The animation state includes an index. The animation parameters which represents key frame data of the animation state in the corresponding time axis are provided for producing animation parameters driving the animation production module. A scenario template of “crying for joy” is shown in FIG. 7.

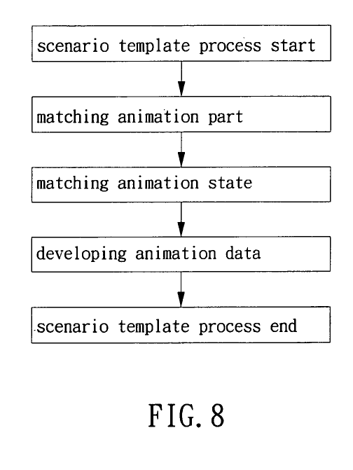

The scenario template processing module expands the scenario template with the audio section in four main steps, (1) dividing the audio sections into groups as many as the animation parts in the scenario template, (2) the animation part distribution, (3) the animation state distribution and (4) the animation data distribution. The procedure is shown in FIG. 8.

In the animation part distribution, the audio section is equally divided according to the number of the animation parts in the scenario template, the energy difference of the individual audio section is calculated, and the energy difference of the individual audio section is calculated again with shifting the dividing point. The calculation is repeated until the most different energy is obtained at which time the dividing point is the optimal dividing point. After the distributing procedure, the sequence of the animation part is not changed and the dividing point is optimal.

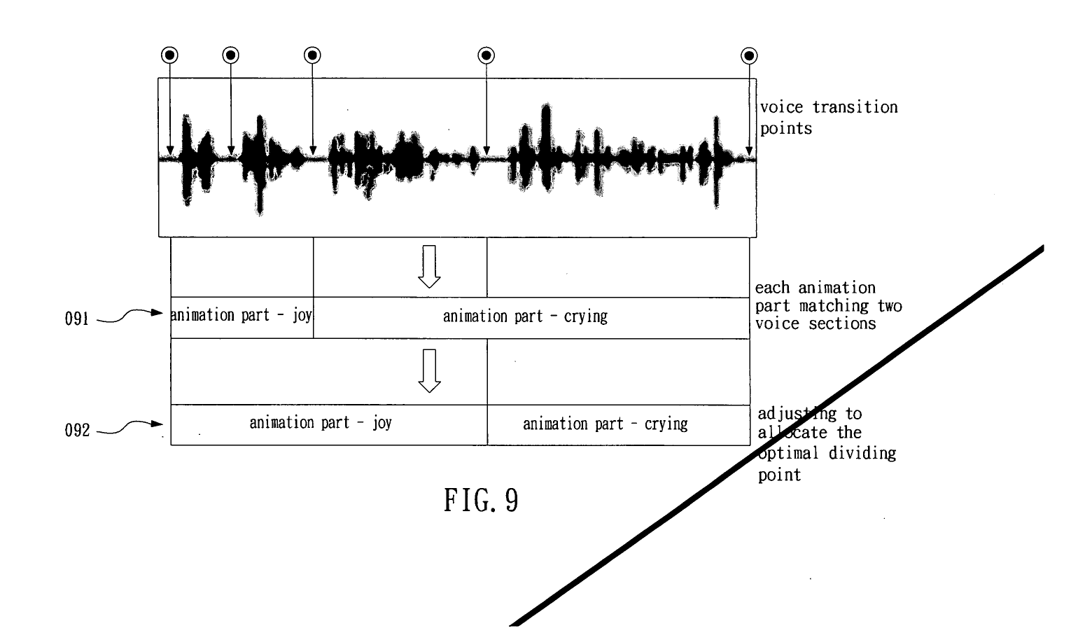

FIG. 9 shows the match of animation parts including a “joy” and a “crying” in the scenario template of “crying for joy”. Number 091 represents the match result of equal division, and number 092 represents the match result of optimal division.

In the animation state distributing, the animation state of each animation part is processed to make each audio section of the animation part match with an animation state. The animation state can be reused. The processing can be based on the index or probability model of audio analysis.

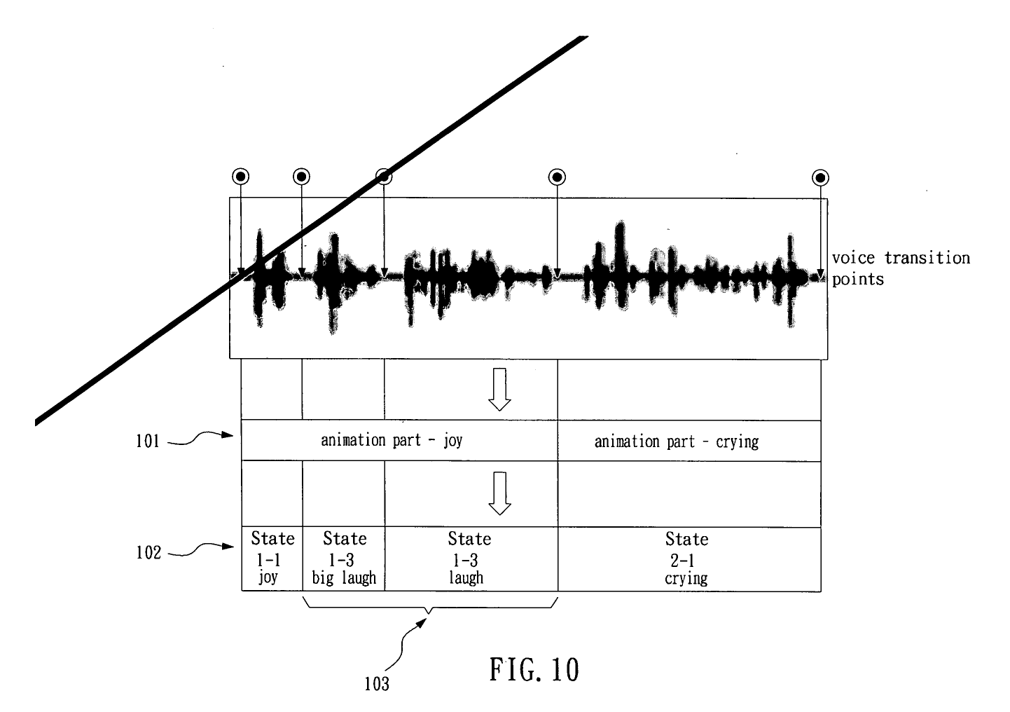

In FIG. 10, a distribution result of a set of animation states in “crying for joy” is shown. Number 101 represents the matched animation part, number 102 represents the animation state matched according to the index, and number 103 represents the animation state of audio characteristic in accompany with probability model.

In the animation expansion, the matched animation state is converted into a key frame in time axis. In the scenario template, each animation state includes an animation track with respect to time axis and a mark representing whether the animation repeats. When the animation state is distributed, the animation track is shifted to the initial time of the matched audio section, and the animation is completed. The mark determines whether the animation is duplicated until the audio section ends.

As described above, the scenario template processing module can match a facial image with the audio data to create animation, wherein the scenario template provides a specific facial animation scenario which includes an animation part, an animation state and animation parameter. The scenario template is a kind of data prepared by certain tool program and stored in the scenario template database or in typical storage device, and is selected via a template selection interface 0151. In real conditions, various scenario templates are created according to different requirements. The number of the templates also depends on requirements. In addition, the scenario template can also be downloaded to commercial equipment via network (such as Internet) or other way (such as a mobile phone) to achieve a system with expandable data.

When processed with the described procedure, the animation parameters and audio data are input to the animation production module to create the final animation.

The animation production module can also be a 2D or 3D module for creating animation in accompany with emitting sound and key frame data.

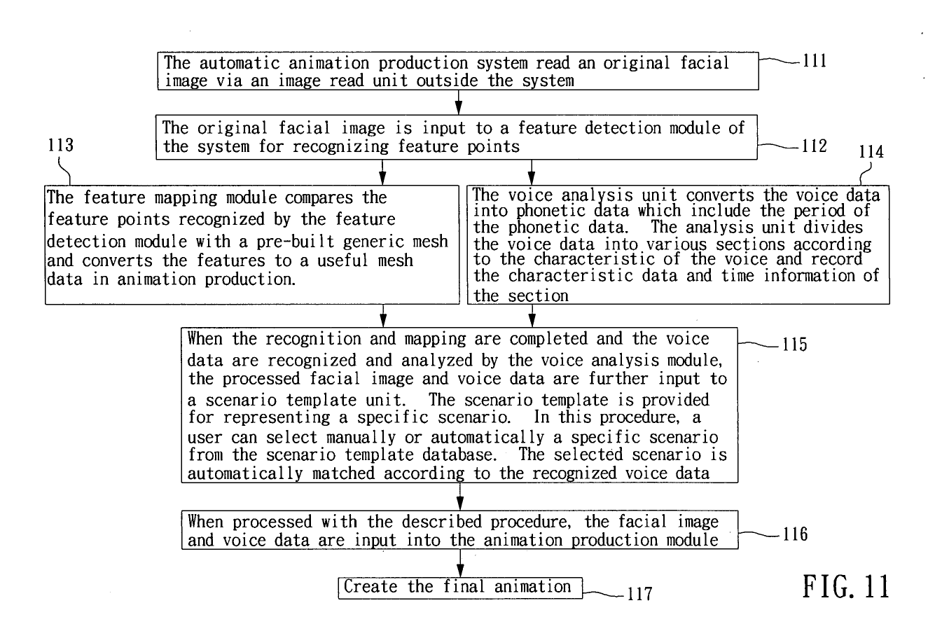

To further understand the correlation between the units in animation production system, an automatic animation production system driven by audio to create facial expression is described. FIG. 11 is a flow chart showing operation of a system of the present invention. As shown in FIG. 11, in the beginning, the automatic animation production system read an original facial image via an image read unit outside the system (step 111). The original facial image is input to a feature detection module of the system for recognizing feature points (step 112). After the recognition, the related facial features are positioned. The geometry construction module compares the feature points recognized by the feature detection module with a pre-built generic mesh and converts the features to a useful geometry data in animation production.

Prior to, after or in the recognition procedure, a user can record audio data which is recognized and analyzed by the audio analysis module (step 114). The voice analysis unit converts the audio data into phonetic data which include the period of the phonetic data. The audio analysis unit divides the audio data into various sections according to the characteristic of the audio and outputs the characteristic data and time information of the section to the scenario template processing module.

When the recognition and mapping are completed and the audio data are recognized and analyzed by the audio analysis module, the processed audio data are further input to a scenario template processing module. The scenario template is provided for representing a specific scenario. In this procedure, a user can select manually or automatically a specific scenario from the scenario template database. The selected scenario is automatically expanded according to the recognized audio data (step 115). For example, the user probably selects the scenario of “crying for joy”, and the scenario template processing module matches the audio variation with the animation parameter in the scenario of “joy” and “crying” so that image is animated with the audio.

When processed with the described procedure, the animation parameter, geometry data and audio data are input into the animation production module (step 116) to create the final animation (step 117).

In the system described above, if the audio characteristic data in the audio analysis module is omitted, then a system with three animation parts; the intro part, the play part and the ending part, is obtained. The beginning and ending of the audio can be served as the division points to match the parts in the scenario template. In this simple system, the intro part and the ending part can include only one animation state without reuse. The play part has one or more animation states which can be indexed or reused. Such a system is very suitable for a system with limited capability such as a handheld devices or a mobile phone using shorter audio data.

In the described system, an enriched facial expression effect can also be obtained by event driving rather than audio analysis. Events serve as the division points to match the parts in the scenario template.

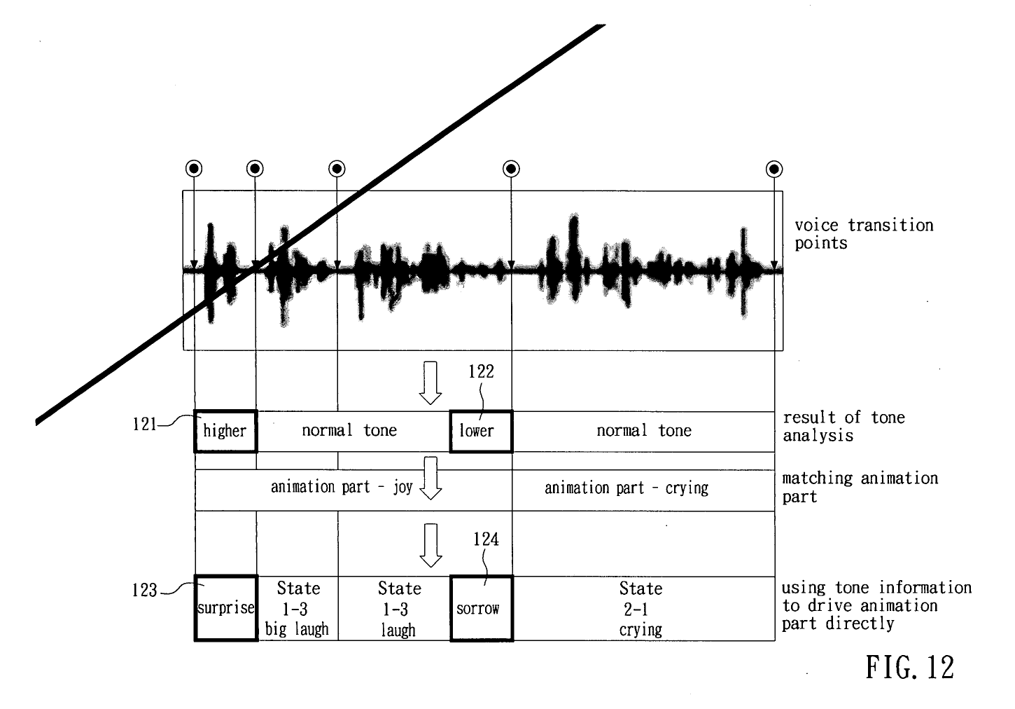

The present invention also can use the audio characteristic obtained from the audio analysis module as “event” to drive animation part. Referring to FIG. 12, different audio characteristics are being used as events to match different animation parts, as shown, the audio with higher tone 121 is matched to the animation part of surprise 123 and the audio with lower tone 122 is matched to the animation part of sorrow 124 respectively. That is, the appearance of these two animation parts can be controlled by the tone of audio.

The general property of audio can be put into consideration as factor when the audio analysis module of the present invention analyses an audio. For example, the different rhythm of audio can be used as break, so that each different rhythm match different animation parts stored in a scenario template processing module to generate a animation. In such a case when applying on an animation of human figure, the figure is performing dance along the flow of the rhythm.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. An automatic animation production system driven by audio or events triggered by audio signals to produce animations according to selected scenarios, comprising:
a scenario selection interface for selecting at least one scenario template;
a scenario template database storing a plurality of scenario template data;
a scenario template processing module processing the selected scenario template data to generate a dynamic sequence of animation parameters synchronized to the audio or events; and
an animation production module loading the dynamic sequence of animation parameters to complete animation frames from which animations are produced.

2. The automatic animation production system as claimed in claim 1 further comprising:
a feature detection module identifying the features of an input image;
a geometry construction module constructing the identified input image which is a facial image into geometry data; and
an audio analysis module analyzing the audio to generate a mouth shape transition data and the synchronized events triggered/driven by the audio signals.

3. The automatic animation production system as claimed in claim 2, wherein the animation production module is provided for adjusting the geometry data according to the dynamic sequence of animation parameters in accompany with the audio and the mouth shape transition data to produce animations.

4. The automatic animation production system as claimed in claim 2, wherein the geometry construction module utilizes a progressive construction method which comprises the following steps:
(a) building a finest feature point set for the facial image and dividing the features of the facial image into various groups according to different facial portions;
(b) defining a plurality of levels of detail and establishing mapping correlation between the levels according to the finest feature point set;
(c) loading the identified feature of the facial image as a current level;
(d) adjusting features of a next finer level with the features of the current level;
(e) repeating step (d) until a finest feature is available; and
(f) constructing the geometry data with the finest feature.

5. The automatic animation production system as claimed in claim 1, wherein the scenario template data further comprising:
(a) a plurality of groups of animation part data for presenting sequential animations;
(b) each animation part data comprising a plurality of groups of animation state data for indexing or randomly expanding to sections of the animation part data;
(c) animation parameters data corresponding to each group of animation state data; and
(d) a hierarchical data structure comprising the animation part data;
animation state data and animation parameters data.

6. The automatic animation production system as claimed in claim 2, wherein the scenario template data further comprising:
(a) a plurality of groups of animation part data for presenting sequential animations;
(b) each animation part data comprising a plurality of groups of animation state data for indexing or randomly expanding to sections of the animation part data;
(c) animation parameters data corresponding to each group of animation state data; and
(d) a hierarchical data structure comprising the animation part data;
animation state data and animation parameters data.

7. The automatic animation production system as claimed in claim 1 wherein a expansion process in the scenario template processing module comprises the following steps:
(a) dividing the audio or events into groups as many as the animation parts data in the scenario template data;
(b) distributing animation parts of the scenario template on the divided group of the audio or events and maintaining a sequence of the animation parts data;
(c) distributing the animation states data of the scenario template data to constitute animation parts data according to the index or a probability model matching; and
(d) distributing the animation parameters data of the scenario template data for outputting the dynamic sequence of the animation parameters corresponding to the animation state data.

8. The automatic animation production system as claimed in claim 2, wherein a expansion process in the scenario template processing module comprises the following steps:
(a) dividing the events into groups as many as the animation parts data in the scenario template data;
(b) distributing animation parts of the scenario template on the divided group of the events and maintaining a sequence of the animation parts data;
(c) distributing the animation states data of the scenario template data to constitute animation parts data according to the index or a probability model matching; and
(d) distributing the animation parameters data of the scenario template data for outputting the dynamic sequence of the animation parameters corresponding to the animation state data.

9. The automatic animation production system as claimed in claim 1, wherein the scenario template comprises a dynamic sequence of animation parameters with variations of facial feature, texture of facial image or cartoon symbols.

10. The automatic animation production system as claimed in claim 2 wherein the scenario template comprises a dynamic sequence of animation parameters with variations of facial feature, texture of facial image or cartoon symbols.

11. A automatic animation production method, comprising the following steps:
(a) preparing geometry data for a animation production module
(b) loading scenario templates data selected manually or automatically from a scenario template database using a scenario selection interface;
(c) expanding the selected scenario template data to generate a dynamic sequence of animation parameters based on audio or events triggered by audio signals using a scenario template processing module to create animations; and
(d) receiving the dynamic sequence of animation parameters to generate animation frames using the animation production module.

12. The automatic animation production method as claimed in claim 11, wherein the step (a) further comprises the following steps:
(a1) loading a facial image;
(a2) recognizing and positioning features of the facial image using a feature detection module; and
(a3) constructing geometry data according to the recognized features using a geometry constructing module.

13. The automatic animation production method as claimed in claim 11, wherein the step (c) further comprises the following steps:
(c1) loading audio data
(c2) analyzing the audio data to generate the events using a audio analysis module; and
(c3) expanding the selected scenario template data to generate a dynamic sequence of animation parameters based on the events using a scenario template processing module to create animations.

14. The automatic animation production system as claimed in claim 13, wherein the step (c3) further comprising the following steps:
(c3-1) dividing the events into groups as many as the animation parts data in the scenario template data;
(c3-2) distributing the animation parts data of the scenario template data on the divided groups of the events and maintaining a sequence of the animation parts data;
(c3-3) distributing animation states data of the scenario template to constitute the animation parts data according to a index or a probability model matching; and
(c3-4) distributing the animation parameters data of the scenario template data for outputting the dynamic sequence of the animation parameters corresponding to the animation state data.

15. The automatic animation production method as claimed in claim 11, wherein the order of steps (a)(b)(c)(d) can be (b)(c)(a)(d).

16. The automatic animation production system as claimed in claim 11, wherein the scenario template data comprises a dynamic sequence of animation parameters with variations of facial feature, texture of facial image or cartoon symbols.

17. The automatic animation production system as claimed in claim 12, wherein the scenario template data comprises a dynamic sequence of animation parameters with variations of facial feature, texture of facial image or cartoon symbols.

18. The automatic animation production system as claimed in claim 13, wherein the scenario template data comprises a dynamic sequence of animation parameters with variations of facial feature, texture of facial image or cartoon symbols.

19. The automatic animation production system as claimed in claim 14, wherein the scenario template data comprises a dynamic sequence of animation parameters with variations of facial feature, texture of facial image or cartoon symbols.
